(19) United States
(12) Patent Application Publication
(10) Pub. No.: US 2022/0295756 A1
(43) Pub. Date: Sep. 22, 2022

(54) Modular Bird Feeder Assembly

(71) Applicant: Danny Crass, Lenoir City, TN (US)

(72) Inventor: Danny Crass, Lenoir City, TN (US)

(21) Appl. No.: 17/202,429

(22) Filed: Mar. 16, 2021

(51) Int. Cl. A01K 39/01; A01K 39/012

(52) U.S. Cl. CPC A01K 39/0113; A01K 39/012

(57) ABSTRACT

A modular bird feeder assembly includes a bird feeder that has the ornamental appearance of a log. The bird feeder has a plurality of protrusions each extending outwardly therefrom to simulate the appearance of branches extending away from the log. Additionally, the bird feeder has an axe integrated therein to enhance the ornamental appearance of the log. A chain is coupled to the bird feeder and a dish is removably attachable to the chain such that the bird feeder is suspended from the dish. The dish can be suspended from a support thereby facilitating the bird feeder to be elevated. A pole is provided that is removably attachable to the plate and the pole can be inserted into a support surface. In this way the bird feeder can be supported above the support surface rather than being suspended from the support.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to feeder devices and more particularly pertains to a new feeder device for feeding birds. The device includes a feeder that has the ornamental appearance of a log and a dish for collecting rain water. The dish can be suspended from a support and the feeder can be suspended from the dish. Additionally, a pole is provided that can be inserted into a support surface and the feeder can be positioned on top of the pole rather than being suspended from the support.

### (2) Description of Related Art Including Information Disclosed Under 37 CFR 1.97 and 1.98

The prior art relates to feeder devices including a bird feeder that includes a pole having an auger integrated thereon for elevating a bird feeder above a support surface. The prior art discloses a variety of bird feeders that can be suspended from a support. The prior art discloses a variety of modular bird feeders that can be assembled in a variety of configurations. In no instance does the prior art disclose a modular bird feeder that has the ornamental appearance of a log.

### BRIEF SUMMARY OF THE INVENTION

An embodiment of the disclosure meets the needs presented above by generally comprising a bird feeder that has the ornamental appearance of a log. The bird feeder has a plurality of protrusions each extending outwardly therefrom to simulate the appearance of branches extending away from the log. Additionally, the bird feeder has an axe integrated therein to enhance the ornamental appearance of the log. A chain is coupled to the bird feeder and a dish is removably attachable to the chain such that the bird feeder is suspended from the dish. The dish can be suspended from a support thereby facilitating the bird feeder to be elevated. A pole is provided that is removably attachable to the plate and the pole can be inserted into a support surface. In this way the bird feeder can be supported above the support surface rather than being suspended from the support.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a modular bird feeder assembly according to an embodiment of the disclosure.

FIG. 2 is a front view of an embodiment of the disclosure.

FIG. 3 is a perspective in-use view of an embodiment of the disclosure showing a bird feeder suspended from a support.

FIG. 4 is a cross sectional view taken along line 4-4 of FIG. 3 of an embodiment of the disclosure.

FIG. 5 is a perspective in-use view of an embodiment of the disclosure.

### DETAILED DESCRIPTION OF THE INVENTION

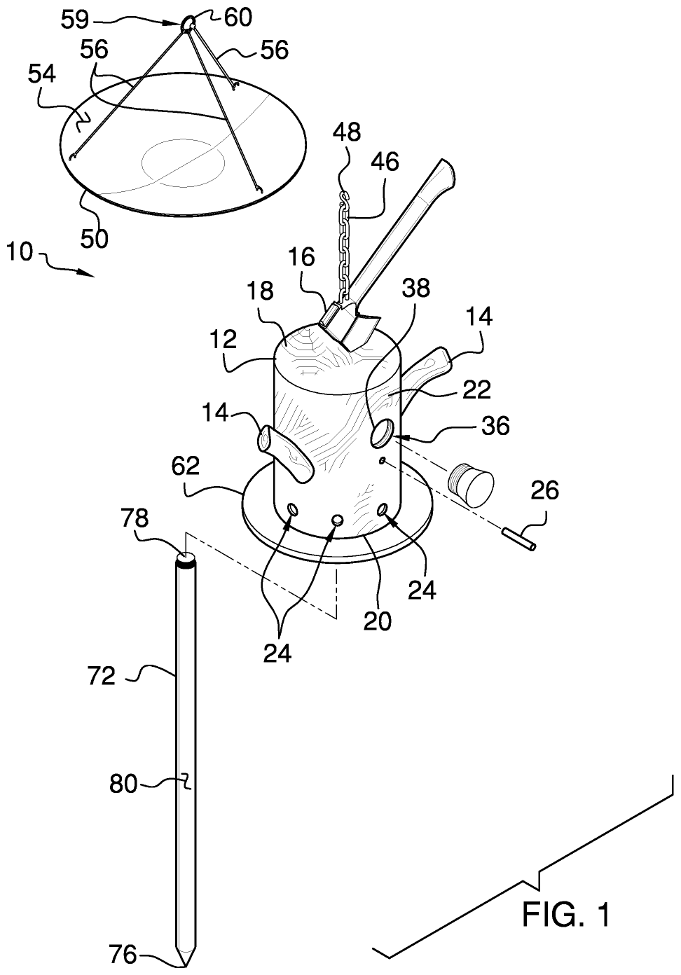

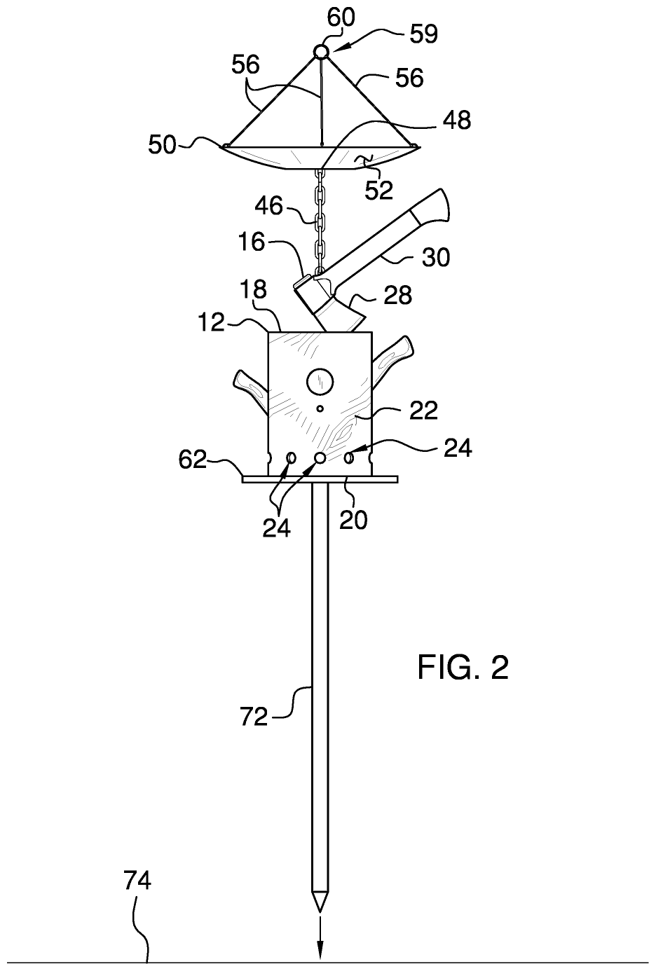

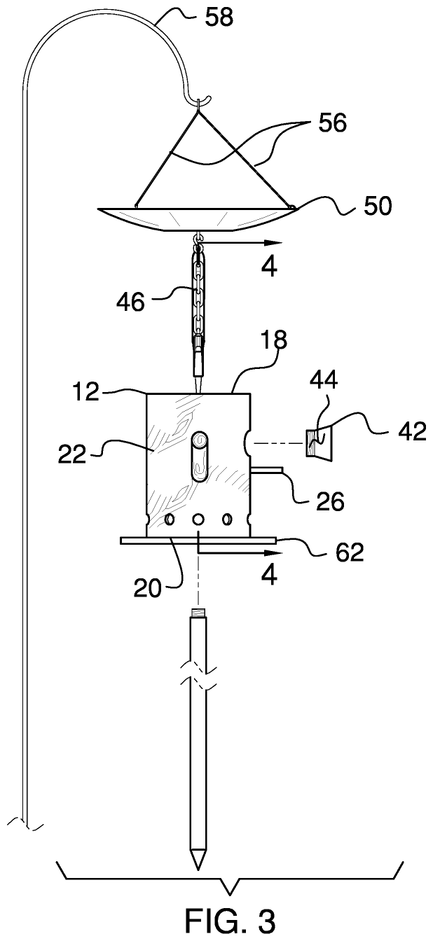

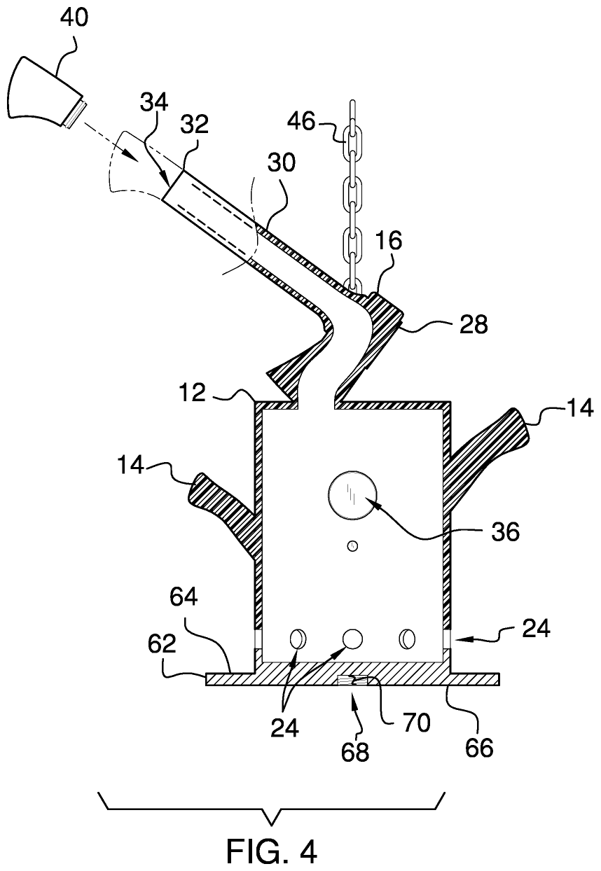

With reference now to the drawings, and in particular to FIGS. 1 through 5 thereof, a new feeder device embodying the principles and concepts of an embodiment of the disclosure and generally designated by the reference numeral 10 will be described.

As best illustrated in FIGS. 1 through 5, the modular bird feeder assembly 10 generally comprises a bird feeder 12 has a cylindrical shape such that the bird feeder 12 has the ornamental appearance of a log. The bird feeder 12 has a plurality of protrusions 14 each extending outwardly therefrom to simulate the appearance of branches extending away from the log. The bird feeder 12 is hollow thereby facilitating the bird feeder 12 to contain bird feed 15. Additionally, an axe 16 is integrated into the bird feeder 12 to enhance the ornamental appearance of the log.

The bird feeder 12 has a top wall 18, a bottom wall 20 and an outer wall 22 extending therebetween, and each of the protrusions 14 extends outwardly from the outer wall 22. Additionally, the outer wall 22 may be textured to have the ornamental appearance of bark on the log. The outer wall 22 has a plurality of feed openings 24 each extending into an interior of the bird feeder 12 to facilitate birds to eat the bird feed 15. The feed openings 24 are spaced apart from each other and are distributed around a full circumference of the outer wall 22. Additionally, each of the feed openings 24 is positioned adjacent to the bottom wall 20. A peg 26 is provided and the peg 26 is insertable into a predetermined location on the outer wall 22 of the bird feeder 12 thereby facilitating a bird to perch on the peg 26.

The axe 16 has a head 28 and a handle 30, and the head 28 is integrated into the top wall 18 of the bird feeder 12 having the handle 30 angling upwardly from the head 28. The axe 16 is hollow and the axe 16 is in fluid communication with the interior of the bird feeder 12. The handle 30 has a distal end 32 with respect to the head 28 the distal end 32 of the handle 30 has an opening 34 extending therethrough. Moreover, the opening 34 facilitates the bird feeder 12 to be filled with bird feed 15. The outer wall 22 of the bird feeder 12 has an opening 36 extending into an interior of the bird feeder 12 to facilitate the bird feeder 12 to be filled with bird feed 15, and the opening 36 in the outer wall 22 has a bounding edge 38.

A plug 40 is insertable into the opening 34 in the distal end 32 of the handle 30 of the axe 16 for closing the opening 34 in the distal end 32. A cap 42 is provided that has an outer surface 44 that is threaded and the cap 42 is insertable into the opening 36 in the outer wall 22 of the bird feeder 12. Additionally, the outer surface 44 threadably engages the bounding edge 38 of the opening 36 in the outer wall 22 for retaining the cap 42 in the opening 36 in the outer wall 22. A chain 46 is coupled to the bird feeder 12, the chain 46 extends away from the head 28 of the axe 16 and the chain 46 has a distal end 48 with respect to the head 28.

A dish 50 is provided and the chain 46 is removably attachable to the dish 50 such that the bird feeder 12 is suspended from the dish 50. The dish 50 has a bottom surface 52 and a top surface 54, and the top surface 54 is concavely arcuate. In this way the dish 50 can collect rain water to facilitate the birds to drink. Additionally, the distal end 48 of the chain 46 is coupled to the bottom surface 52. A plurality of rods 56 is each of the rods 56 is coupled to and extends upwardly from the dish 50. In this way each of the rods 56 is configured to be coupled to a support 58 for suspending the dish 50 from the support. Additionally, each of the rods 56 is positioned on the top surface 54 of the dish 50, and the rods 56 angle toward each other and intersects at a central point 59.

A ring 60 is coupled to the central point 59 at which the rods 56 intersect and the ring 60 can engage the support 58. The support 58 might be a tree branch or other elevated support that is capable of supporting the weight of the bird feeder 12 and the dish 50. A plate 62 is removably attachable to the bird feeder 12 such that the bird feeder 12 rests on the plate 62. Additionally, the plate 62 can be attached to the bird feeder 12 when the bird feeder 12 is not being suspended from the support. The plate 62 has an upper surface 64 and a lower surface 66, and the upper surface 64 removably engages the bottom wall 20 of the bird feeder 12. The lower surface 66 has a well 68 extending toward the upper surface 64, the well 68 has a bounding surface 70 and the bounding surface 70 is threaded.

A pole 72 is provided removably attachable to the plate 62 thereby facilitating the pole 72 to be inserted into a support surface 74 for supporting the bird feeder 12 above the support surface 74. The support surface 74 may be the ground or other horizontal support surface. The pole 72 has a first end 76, a second end 78 and an outer surface 80 extending therebetween, and the first end 76 tapers to a point to penetrate the support surface 74. The outer surface 80 is threaded adjacent to the second end 78 and the second end 78 is insertable into the well 68 in the plate 62 having the outer surface 80 threadably engaging the bounding surface 70 of the well 68.

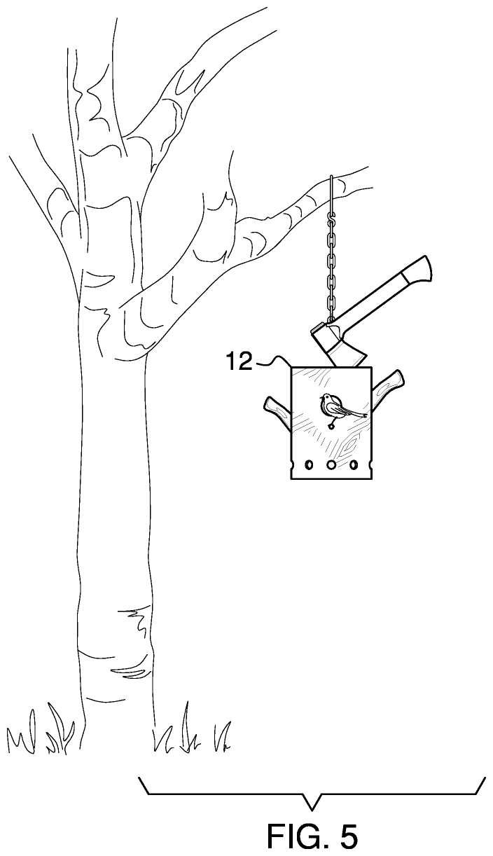

In use, the bird feeder 12 is filled with bird feed 15 and the bird feeder 12 is either suspended from the dish 50 or the bird feeder 12 is positioned on the pole 72. In this way the bird feeder 12 can be elevated to facilitate birds to feed on the bird feed 15. The dish 50 collects rain water when the bird feeder 12 is suspended from the dish 50 to facilitate the birds to drink. Additionally, the ornamental appearance of the bird feeder 12 enhances the visual appeal of the bird feeder 12. As is most clearly shown in FIG. 5, the chain 46 can be attached to the support 58 rather than having the chain 46 being attached to the dish 50.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A modular bird feeder assembly for feeding birds in a variety of configurations, said assembly comprising:
a bird feeder having a cylindrical shape wherein said bird feeder is configured to have the ornamental appearance of a log, said bird feeder having a plurality of protrusions each extending outwardly therefrom wherein each of said protrusions is configured to simulate the appearance of branches extending away from the log, said bird feeder being hollow wherein said bird feeder is configured to contain bird feed, said bird feeder having an axe being integrated therein wherein said axe is configured to enhance the ornamental appearance of the log;
a chain being coupled to said bird feeder;
a dish being having said chain being removably attachable thereof such that said bird feeder is suspended from said dish;
a plurality of rods, each of said rods being coupled to and extending upwardly from said dish wherein each of said rods is configured to be coupled to a support for suspending said dish from the support;
a plate being removably attachable to said bird feeder such that said bird feeder rests on said plate; and
a pole being removably attachable to said plate wherein said pole is configured to be inserted into a support surface for supporting said bird feeder above the support surface.

2. The assembly according to claim 1, wherein said bird feeder has a top wall, a bottom wall and an outer wall extending therebetween, said outer wall having a plurality of feed openings each extending into an interior of said bird feeder wherein each of said feed openings is configured to facilitate birds to eat the bird feed, said feed openings being spaced apart from each other and being distributed around a full circumference of said outer wall, each of said feed openings being positioned adjacent to said bottom wall.

3. The assembly according to claim 2, wherein said axe has a head and a handle, said head being integrated into said top wall of said bird feeder having said handle angling upwardly from said head, said handle having a distal end with respect to said head, said axe being hollow, said axe being in fluid communication with said interior of said bird feeder, said distal end of said handle having an opening extending therethrough wherein said opening is configured to facilitate said bird feeder to be filled with bird feed.

4. The assembly according to claim 2, wherein said outer wall of said bird feeder has an opening extending into an interior of said bird feeder wherein said opening in said outer wall is configured to facilitate said bird feeder to be filled with bird feed, said opening in said outer wall having a bounding edge.

5. The assembly according to claim 3, further comprising a plug being insertable into said opening in said distal end of said handle of said axe for closing said opening in said distal end.

6. The assembly according to claim 4, further comprising a cap has an outer surface being threaded, said cap being insertable into said opening in said outer wall of said bird feeder having said outer surface threadably engaging said bounding edge of said opening in said outer wall.

7. The assembly according to claim 3, wherein said chain extends away from said head of said axe, said chain having a distal end with respect to said head.

8. The assembly according to claim 7, wherein said dish has a bottom surface and a top surface, said top surface being concavely arcuate wherein said dish is configured to collect rain water to facilitate the birds to drink, said distal end of said chain being coupled to said bottom surface.

9. The assembly according to claim 8, wherein:
each of said rods is positioned on said top surface of said dish, said rods angling toward each other and intersecting at a central point; and
said assembly includes a ring being coupled to said central point at which said rods intersect wherein said ring is configured to engage the support.

10. The assembly according to claim 2, wherein said plate has an upper surface and a lower surface, said upper surface removably engaging said bottom wall of said bird feeder, said lower surface having a well extending toward said upper surface, said well having a bounding surface, said bounding surface being threaded.

11. The assembly according to claim 10, wherein said pole has a first end, a second end and an outer surface extending therebetween, said first end tapering to a point wherein said first end is configured to penetrate the support surface, said outer surface being threaded adjacent to said second end, said second end being insertable into said well in said plate having said outer surface threadably engaging said bounding surface of said well.

12. A modular bird feeder assembly for feeding birds in a variety of configurations, said assembly comprising:
a bird feeder having a cylindrical shape wherein said bird feeder is configured to have the ornamental appearance of a log, said bird feeder having a plurality of protrusions each extending outwardly therefrom wherein each of said protrusions is configured to simulate the appearance of branches extending away from the log, said bird feeder being hollow wherein said bird feeder is configured to contain bird feed, said bird feeder having an axe being integrated therein wherein said axe is configured to enhance the ornamental appearance of the log, said bird feeder having a top wall, a bottom wall and an outer wall extending therebetween, said outer wall having a plurality of feed openings each extending into an interior of said bird feeder wherein each of said feed openings is configured to facilitate birds to eat the bird feed, said feed openings being spaced apart from each other and being distributed around a full circumference of said outer wall, each of said feed openings being positioned adjacent to said bottom wall, said axe having a head and a handle, said head being integrated into said top wall of said bird feeder having said handle angling upwardly from said head, said handle having a distal end with respect to said head, said axe being hollow, said axe being in fluid communication with said interior of said bird feeder, said distal end of said handle having an opening extending therethrough wherein said opening is configured to facilitate said bird feeder to be filled with bird feed, said outer wall of said bird feeder having an opening extending into an interior of said bird feeder wherein said opening in said outer wall is configured to facilitate said bird feeder to be filled with bird feed, said opening in said outer wall having a bounding edge;
a plug being insertable into said opening in said distal end of said handle of said axe for closing said opening in said distal end;
a cap having an outer surface being threaded, said cap being insertable into said opening in said outer wall of said bird feeder having said outer surface threadably engaging said bounding edge of said opening in said outer wall;
a chain being coupled to said bird feeder, said chain extending away from said head of said axe, said chain having a distal end with respect to said head;
a dish being having said chain being removably attachable thereof such that said bird feeder is suspended from said dish, said dish having a bottom surface and a top surface, said top surface being concavely arcuate wherein said dish is configured to collect rain water to facilitate the birds to drink, said distal end of said chain being coupled to said bottom surface;
a plurality of rods, each of said rods being coupled to and extending upwardly from said dish wherein each of said rods is configured to be coupled to a support for suspending said dish from the support, each of said rods being positioned on said top surface of said dish, said rods angling toward each other and intersecting at a central point;
a ring being coupled to said central point at which said rods intersect wherein said ring is configured to engage the support;
a plate being removably attachable to said bird feeder such that said bird feeder rests on said plate, said plate having an upper surface and a lower surface, said upper surface removably engaging said bottom wall of said bird feeder, said lower surface having a well extending toward said upper surface, said well having a bounding surface, said bounding surface being threaded; and
a pole being removably attachable to said plate wherein said pole is configured to be inserted into a support surface for supporting said bird feeder above the support surface, said pole having a first end, a second end and an outer surface extending therebetween, said first end tapering to a point wherein said first end is configured to penetrate the support surface, said outer surface being threaded adjacent to said second end, said second end being insertable into said well in said plate having said outer surface threadably engaging said bounding surface of said well.
